(19) United States
(12) Patent Application Publication
(10) Pub. No.: US 2009/0199735 A1
(43) Pub. Date: Aug. 13, 2009

(54) Fastener for pyrotechnic element

(75) Inventor: Yuval Haim Dagan, Kiriat Ono (IL)

Correspondence Address: Yuval Haim Dagan, Yanush Korchack 11, Kiriat Ono, 55602, IL

(73) Assignee: Yuval Haim Dagan, Kiriat Ono (IL)

(21) Appl. No.: 12/370,563

(22) Filed: Feb. 12, 2009

Related U.S. Application Data
(60) Provisional application No. 61/028,359, filed on Feb. 13, 2008.

(51) Int. Cl. F42B 4/00; G09F 1/00; C06F 5/00

(52) U.S. Cl. 102/358; 40/124.09; 102/335; 44/507

(57) ABSTRACT

A fastener device of the present invention is made for connecting pyrotechnic elements such as lances, gerbs and sparklers to a frame. This novelty fastener is comprised with a spring portion which allows the bending of the pyrotechnic element to lay against the surface of the frame. The fastener makes it possible to mount pyrotechnic material in a remote location, attach the ignition fuse but use less space on the truck in transportation and cause less damage to the pyrotechnic elements during the process. Another embodiment of the fastener is used in a novelty greeting card device for the enjoyment of the general public. A suggested embodiment of the novelty fastener is combined with pyrotechnic material to form a novelty sparkler device.

This application claims the benefit of a provisional application No. 61/028,359 field 13 Feb. 2008.

### FIELD OF THE INVENTION

The present invention relates to a fastener for pyrotechnic elements. The first embodiment of the fastener is for use in pyrotechnic display device known as fireworks set pieces. Another embodiment of the fastener is used for creating a novelty consumer's item. In the field of greeting cards. Yet another alternate embodiment of the suggested fastener is a novelty sparkler device.

### BACKGROUND OF THE INVENTION

Pyrotechnic fasteners are a part of the art and technique of creating fireworks displays and consumer's items since this craft started. Pyrotechnic element fasteners for creating set pieces that include a plurality of pyrotechnic devices as shown in U.S. Pat. No. 1,976,844 are well known in the art. Exemplary pyrotechnic fastening device is disclosed in U.S. Pat. No. 1,761,094 incorporated herein by reference in its entirety, wherein a display including plurality of lances carried by a support and means for igniting groups of the lances is described. For those who are skilled in the art it is known that there are a few other means for fastening such as double pointed nail and plastic tubes holder that get the same result.

In the professional field of fireworks set pieces display items there is an unmet need for pyrotechnic elements including lances, gerbs and sparklers configured for easy attachment and removal to support frame in order to create pyrotechnic displays involving a large number of such elements with a minimal amount of effort and time. For those who are skilled in the art, it is well known that the pyrotechnic elements mostly the lances are fragile thus making the transportation of the set pieces from a warehouse to the display site complicated, dangerous and expensive because of the big space it take on the trucks. There is unmet need for the volume of the finished items to be reduced allowing more cost effective transportation and the handling of the devices in a safer way for the fireworks crew.

In the field of greeting card items there are inventions that comprise of different electronic items and other tricks embedded. Exemplary greeting card is disclosed in U.S. Pat. No. 5,906,063 in its entirety. The connection between greeting cards and happy events such as birthdays, holidays and national days is obvious. The same events are being celebrated with pyrotechnics in most of the places where it is legal. The novelty and beauty of the current invention is the way it combines between the two symbolic items into one device. The fabrication of the greeting card is most likely relevant to be with sparklers because of their safe characters, physical properties and regulations connected with their use. There are different types and designs of sparklers. Exemplary invention is disclosed in U.S. Pat. No. 6,718,882 in its entirety. This and other inventions made the sparklers safer and more attractive for use. The common way of using sparklers is by holding them in the hand and lighting them. There were also inventions for sparklers that are attached to devices with mechanical function as shown in U.S. Pat. No. 1,522,313 thus making them a display item.

### SUMMARY OF THE INVENTION

In view of the forgoing disadvantages inherent in the known types of pyrotechnic element fasteners now present in the prior art. The present invention provides a new novelty fastener for pyrotechnic elements used for various types of static display devices.

The general purpose of the present invention, which will be described subsequently in greater detail, is to provide a new novelty fastener apparatus and method which has many of the advantages of the fasteners mentioned heretofore and many novel features which result in a novelty fastener which is not anticipated, obvious, rendered, suggested or even implied by any of the prior art thereof.

According to the teachings of the current invention there is provided a reusable spring fastener for holding a pyrotechnic material such as lances, fountains, sparklers and other static fireworks elements and fuses on a cardboard, wood or other rigid material refereed here as frame. The fastener is fabricated from a single wire in a single process, thus make it very cost affective. The fastener allows the mounting and dismounting of the pyrotechnic element and fuse without tools and in a fast and safe manner. The fastener is used to hold the pyrotechnic element in two positions according to the wish of the user. If desired it has possibility to catch the fuse in a way it will ignite the pyrotechnic element. The positions in which the fastener holds the pyrotechnic element are transportation mode and show mode. The transportation mode occurs when the pyrotechnic element is caught in a position parallel to the frame. In the show mode the pyrotechnic element is held by the force of the fastener in a position perpendicular to the frame. The pyrotechnic element gets to the show mode automatically once ignited by the fuse by the combined forces of the ignition and the spring portion of the fastener.

Another object of the invention is an embodiment of the fastener without the part of the fuse holder. This embodiment is used for creating a novelty greeting card item with a pyrotechnic device embedded in it. The pyrotechnic element, a sparkler is the preferred pyrotechnic element for this use, lays between the two cardboard parts of the greeting card. Once the card is opened the sparkler jumps to a position which is perpendicular to the card board. The ignition of the pyrotechnic element is done by the card receiver. Once the pyrotechnic element is used it is possible to disassemble it from the fastener without any tool.

For the creation of the novelty greeting card item a novelty sparkler device is introduced. In the suggested embodiment, instead the mounting portion of the fastener, the wire is used as bonding surface for the pyrotechnic sparkler material. The sparkler device of this embodiment stands in the mechanical requirements needed for the greeting card item.

### BRIEF DESCRIPTION OF DRAWINGS

The invention will now be described in more detail by means of preferred embodiments, with reference to the drawings, and by a description of some possible variations and alternatives.

FIG. 1 illustrates the complete embodiment of the fastener according to the invention.

FIG. 2 illustrates the transportation mode of set piece assembly with the pyrotechnic element fastener according to the invention.

FIG. 3 illustrates the show mode of set piece assembly with the pyrotechnic element fastener according to the invention.

FIG. 4 illustrates the transportation mode of greeting card assembly with second embodiment of pyrotechnic element fastener according to the invention.

FIG. 5 illustrates the show mode of the greeting card assembly with second embodiment of pyrotechnic element fastener according to the invention.

FIG. 6 illustrates an alternate fastener that is also a sparkler device according to the invention.

### DETAILED DESCRIPTION OF THE PREFERRED EMBODIMENTS

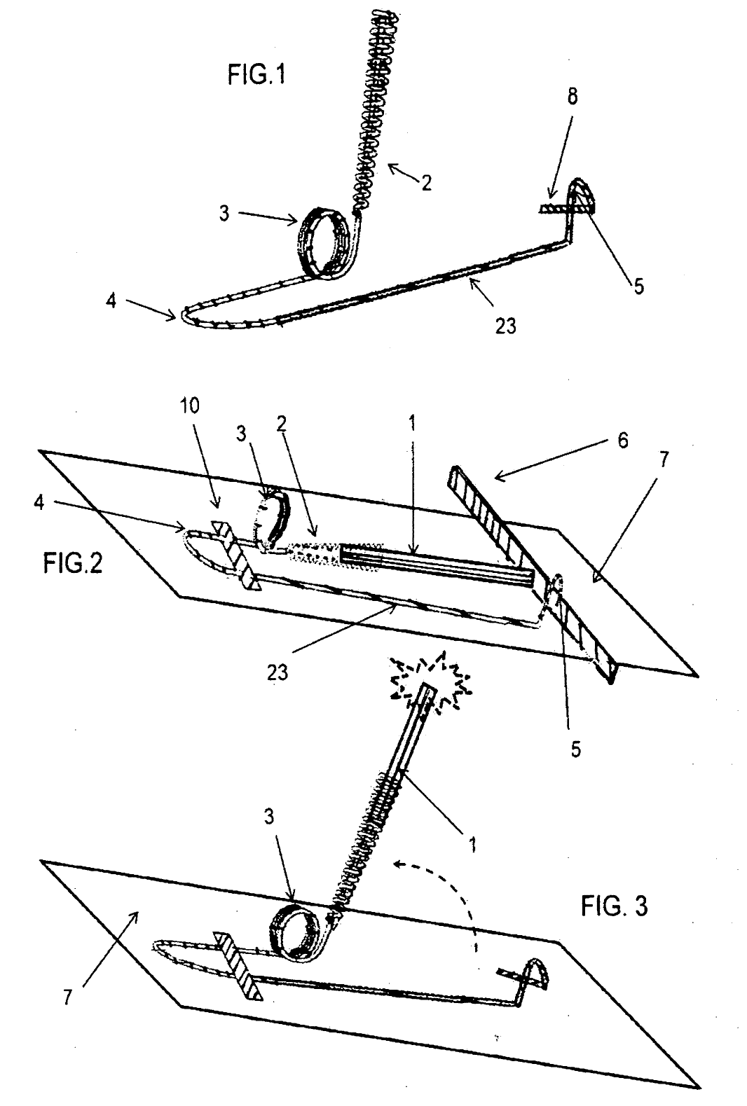

FIG. 1

The preferred embodiment of the novelty fastener is shown here. The fastener is reusable, made out of non flammable material preferably metal but is not limited to it. The fastener has a mounting portion 2 for catching pyrotechnic element. The mounting portion is made of wire coiled helically to form a tubular portion which has a diameter of 1 mm or 10 mm or 20 mm or 30 mm in which, by screwing with the hand or a mechanical device, the tube of a pyrotechnic element is caught under the pressure of the wire thus securing the pyrotechnic element in the mounting portion 2. The helically coiled wire diameter decreases in the direction away from the top of the mounting portion. The same wire from the mounting portion 2 continues to form loops 3 in amount of 1-4 loops, in diameter of 1 mm 2 mm 4 mm 10 mm 20 mm or more, thus creating a torsion spring. The wire continues from the loops to form a U shape 4. This U shape is the base portion 4 and is used to connect the fastener to a frame by mechanical or adhesive means. The wire 23 continues in parallel state to the spring part 3. At the length of the mounted pyrotechnic device, laying in a parallel state to frame 7, the wire form an upside down V shaped hook 5. The leg of the V after the bent point 5 is shorter than the leg before the bent point. This V shape portion is used for catching a fuse. At the end of the shorter leg the wire 8 continues in a parallel state to the frame and in the direction of base portion 4 of the fastener to form a small tong.

FIG. 2

The preferred embodiment of the novelty fastener is shown here in the transportation mode with the entire set piece assembly. The fastener is reusable, made out of non flammable material preferably metal but is not limited to it. The fastener has a mounting portion 2 for catching pyrotechnic element 1. The tube of the pyrotechnic element 1 is caught under the pressure of the wire thus securing the pyrotechnic element in the mounting portion 2. The helically coiled wire diameter decreases in the direction away from the top of the mounting portion 2. The U shape is the base portion 4 and is used to connect the fastener to the frame by mechanical means such as nail 10 or adhesive means such as silicone or any other way. The wire 23 continues in parallel state to the spring part 3. At the length of the mounted pyrotechnic device 1, laying in a parallel state to frame 7, the wire form an upside down V shaped hook 5. This V shape portion is used for catching the fuse 6. The tong as described in FIG.1 creates moderate pressure on the fuse 6 against the pyrotechnic element 1. The fastener is holding the pyrotechnic element parallel to the frame during transportation from the warehouse to the display site and is creating what is referred here as transportation mode.

FIG. 3

The preferred embodiment of the novelty fastener is shown here in the show mode with the entire set piece assembly. Once the fuse is ignited it ignites the pyrotechnic element 1, the pyrotechnic element is than released from the transportation mode, as described in FIG.2, by the pressure caused by the torsion spring 3 portion of the fastener and the pressure caused by the gasses released during the ignition process. The pyrotechnic element turns to a perpendicular to the frame 7 state in the first seconds of burning and forms an angle of 30 to 90 degrees between the pyrotechnic element and the frame depend on the weight of the pyrotechnic element, the strength of the spring, the environmental conditions and method of use thus performing the pyrotechnic show towards the desired direction.

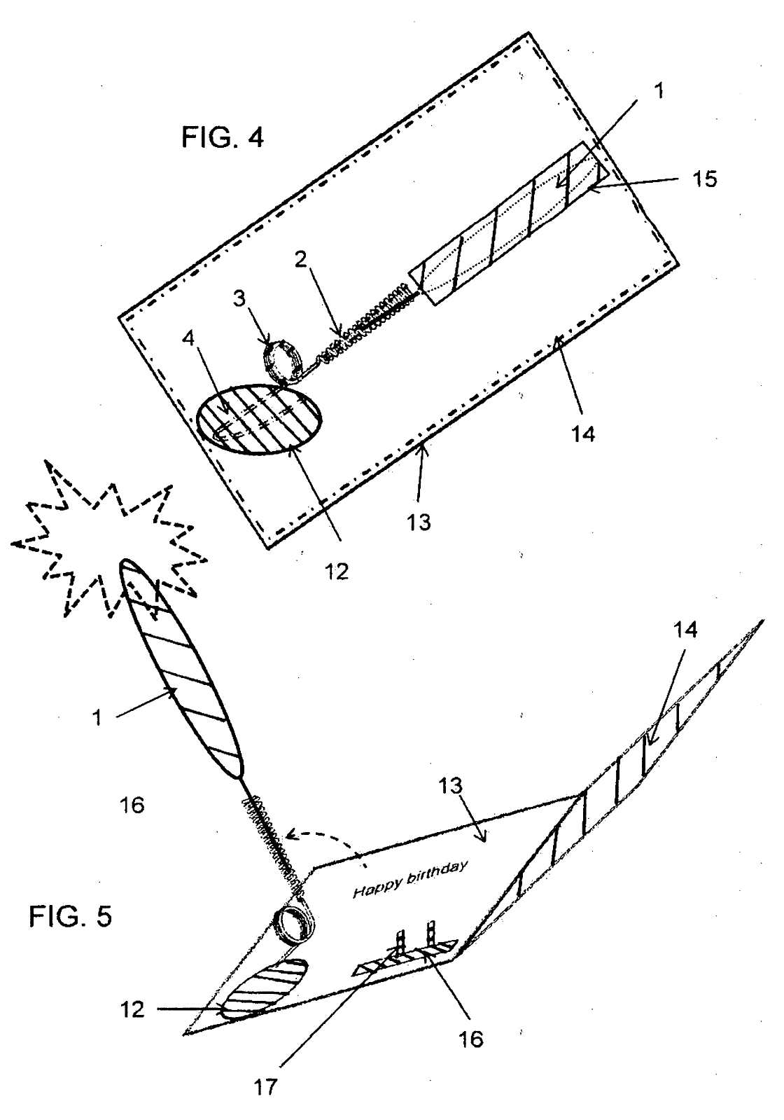

FIG. 4

The preferred embodiment of the novelty fastener for the greeting card device is shown here in the transportation mode with the entire greeting card assembly. The fastener is made out of non flammable material preferably metal but is not limited to it. The fastener has a mounting portion 2 for catching pyrotechnic element 1. The mounting portion is made of wire coiled helically to form a tubular portion which has a diameter of 1 mm or 10 mm in which, by screwing with the hand or a mechanical device, the tube of the pyrotechnic element 1 is caught under the pressure of the wire thus securing the pyrotechnic element in the mounting portion 2. The helically coiled wire diameter decreases in the direction away from the top of the mounting portion 2. The same wire from the mounting portion continues to form loops 3 in amount of 1-4 loops, in diameter of 1 mm 2 mm 4 mm 10 mm 20 mm or more, thus creating a torsion spring. The wire continues from the loops to form a U shape 4. This U shape is the base portion 4 and is used to connect the fastener to the interior surface of the rear panel of the card 13, by mechanical means such as staples, adhesive means such as tape 12 or any other way. While the card is closed, the front panel of the card 14, shown here as a transparent panel, is forming enough pressure to hold the pyrotechnic element 1 in laying position between the interior surfaces of the front and rear panels of the card. For greater safety against accidental ignition and against possible damage for the pyrotechnic device during the transportation process, the pyrotechnic element could be covered with a rigid tube 15 preferably a plastic tube but not to it.

FIG. 5

The preferred embodiment of the novelty fastener for the greeting card device is shown here in the show mode with the entire greeting card assembly. Once the front panel of the card 14 is moved and the card is opened, the pyrotechnic element 1 is released from the greeting card transportation mode, as described in FIG.4, by the pressure caused by the torsion spring portion 3 of the fastener. The pyrotechnic element turns to a position which is perpendicular to the back page of the card 13 and forms an angle of 60 to 90 degrees between the pyrotechnic element and rear panel of the card, depend on the weight of the pyrotechnic element, the strength of the spring, the environmental conditions and method of use. Once the card is opened, the receiver can remove the guarding tube and ignite the pyrotechnic element. For the purpose of ignition there are safety matches 17 and striking surface 16 connected to the interior surface of the rear panel by mechanical mean such as staples or by adhesive means or tape or any other safe way, both items are connected to the interior surface of the card.

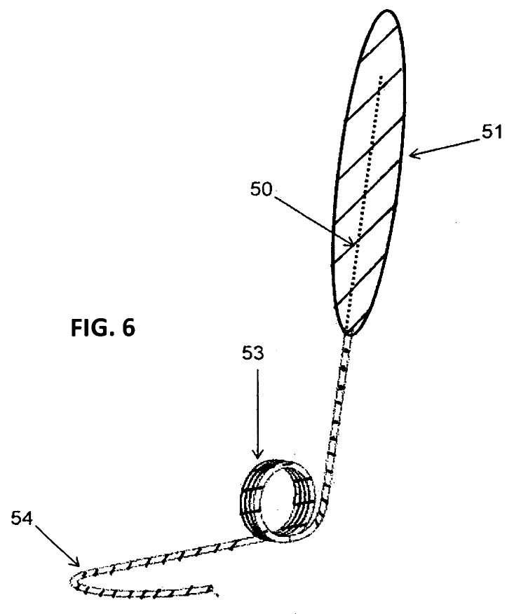

FIG. 6

The embodiment described here is a fastener combined with sparkler on the same wire. The pyrotechnic material 51 is binned to a wire 50 as known in the current practice. The wire 50 continues from the pyrotechnic material part 51 to form loops 53 in amount of 1-4 loops, in diameter of 1 mm 2 mm 4 mm 10 mm 20 mm or more, thus creating a torsion spring. The wire continues from the loops to form a U shape 54. This U shape is the base portion 4 and is used to connect the fastener to the frame of the desired item. This embodiment is intended for use in the greeting card device.

While the invention has been described with respect to a limited number of embodiments, it will be appreciated that many variations, modifications and other applications of the invention may be made.

What is claimed is:

1) A fastener device for connecting a pyrotechnic element to a surface, comprising:
A mounting portion having upper end part, made of helical coiled wire with a maximum diameter of 30 mm, adapted to receive within it and hold firmly an elongated pyrotechnic element, a bottom end of the mounting portion with the diameter of the wire used to fabricate the fastener. A spring portion is connecting between the mounting portion and a base portion for attaching the fastener to a surface by nail, staple, tape or adhesive.

2) A fastener device for connecting a pyrotechnic element to a surface as in claim 1 further comprising,
a second mounting portion for the adaption of pyrotechnic fuse and a tong angled in direction of the mounting portion.

3) The fastener as claimed in claim 2 fabricated from a single metal wire in one fabrication process.

4) The fastener as claimed in claim 2 wherein the said mounting portion is held by the said spring portion perpendicular to the said base portion.

5) The fastener as claimed in claim 2 made of a 0.3 mm diameter wire thickness

6) An assembly of greeting card for providing user enjoyment, comprising:
a front panel and a rear panel, the front panel having a front surface, the rear panel has a rear surface, a plurality of peripheral edges, an interior surface of the front panel and interior surface of the rear panel, wherein the greeting card is operable to be adjusted to a folded condition such that the interior surface of the front panel substantially faces the interior side of the rear panel, further comprising a pyrotechnic device.

7) An assembly of the greeting card as claimed in claim 6 wherein the said pyrotechnic device is fastened to a fastener device for connecting the said pyrotechnic device to the said interior surface of the card, said fastener comprising; A mounting portion having upper end part, made of helical coiled wire with maximum diameter of 10 mm, adapted to receive within it and hold firmly an elongated pyrotechnic element, a bottom end of the mounting portion with the diameter of the wire used to fabricate the fastener. A spring portion is connecting between the mounting portion and a base portion for attaching the fastener to the interior side of the rear panel by, staple, tape or adhesive.

8) An assembly of the greeting card as claimed in claim 6 further comprising; safety matches and matches striking surface both connected to the interior surface of the of the card by adhesive or mechanical means such as staples or tape.

9) An assembly of the greeting card as claimed in claim 6 wherein the said mounting portion is held by the said spring portion perpendicular to the said base portion.

10) An assembly of the greeting card as claimed in claim 6 wherein the fastener is fabricated from a single metal wire in one fabrication process.

11) An assembly of the greeting card as claimed in claim 6 wherein the said rear panel has a hole in it which through it goes out to the said rear surface of the rear panel the base portion of the fastener, and is attached to the rear surface of the rear panel by staple, tape or adhesive.

12) An assembly of the greeting card as claimed in claim 6 wherein the said pyrotechnic device is covered with a rigid tube but is not connected to it.

13) A pyrotechnic element device comprising, pyrotechnic material bonded to a metal wire, a spring portion and a base portion for attaching the device to a surface by nail, staple, tape or adhesive.

14) The pyrotechnic element device as claimed in claim 12 wherein the said metal wire is fabricated from a single wire in one fabrication process.

15) The pyrotechnic element device as claimed in claim 12 wherein the said pyrotechnic material portion is held by the said spring portion perpendicular to the said base portion.

16) The pyrotechnic element device as claimed in claim 12 wherein the said pyrotechnic material portion is held by the said spring portion in an angle of 30 degrees to the said base portion.

17) An assembly of the greeting card as claimed in claim 6 wherein, a pyrotechnic element device further comprise, pyrotechnic material bonded to a metal wire, a spring portion and a base portion for attaching the device to a surface by, staple, tape or adhesive.
